(19) United States
(12) Patent Application Publication
(10) Pub. No.: US 2009/0182871 A1
(43) Pub. Date: Jul. 16, 2009

(54) BACKUP PAGING FOR WIRELESS COMMUNICATION

(75) Inventors: Rajarshi Gupta, Santa Clara, CA (US); Fatih Ulupinar, San Diego, CA (US); Gavin B. Horn, La Jolla, CA (US); Parag A. Agashe, San Diego, CA (US); Ravindra M. Patwardhan, San Diego, CA (US); Rajat Prakash, La Jolla, CA (US)

Correspondence Address: QUALCOMM Incorporated;Patent Department/Central Administration, 5775 Morehouse Drive, San Diego, CA, 92121-1714, US

(73) Assignee: QUALMCOMM Incorporated, San Diego, CA (US)

(21) Appl. No.: 12/352,246

(22) Filed: Jan. 12, 2009

Related U.S. Application Data
(60) Provisional application No. 61/020,973, filed on Jan. 14, 2008.

(51) Int. Cl. G06F 15/173

(52) U.S. Cl. 709/224

(57) ABSTRACT

A backup page is provided for a node that misses a page. In some aspects, a first type of access point in a system provides a backup page for an access terminal that is idling on a second of access point in the system in the event the access terminal misses a page by the second of access point in the system. An access point of the first type may page the access terminal according to a first paging schedule while an access point of the second type may page the access terminal according to a second paging schedule. In some aspects an access point of the first type (e.g., a macro node) provides service over a macro coverage area and an access point of the second type (e.g., a femto node) provides service over a smaller coverage area and/or provides restricted service.

### CLAIM OF PRIORITY

This application claims the benefit of and priority to commonly owned U.S. Provisional Patent Application No. 61/020,973, filed Jan. 14, 2008, and assigned Attorney Docket No. 080204P1, the disclosure of which is hereby incorporated by reference herein.

### BACKGROUND

1. Field

This application relates generally to wireless communication and more specifically, but not exclusively, to improving communication performance.

2. Introduction

Wireless communication systems are widely deployed to provide various types of communication (e.g., voice, data, multimedia services, etc.) to multiple users. As the demand for high-rate and multimedia data services rapidly grows, there lies a challenge to implement efficient and robust communication systems with enhanced performance.

To supplement conventional mobile phone network base stations, small-coverage base stations may be deployed (e.g., installed in a user's home) to provide more robust indoor wireless coverage to mobile units. Such small-coverage base stations are generally known as access point base stations, Home NodeBs, or femto cells. Typically, such small-coverage base stations are connected to the Internet and the mobile operator's network via a DSL router or a cable modem.

Since radio frequency (“RF”) coverage of small-coverage base stations may not be optimized by the mobile operator and deployment of such base stations may be ad-hoc, RF interference issues may arise. Thus, there is a need for improved interference management for wireless networks.

### SUMMARY

A summary of sample aspects of the disclosure follows. It should be understood that any reference to the term aspects herein may refer to one or more aspects of the disclosure.

The disclosure relates in some aspects to providing a backup page for a node that misses a page. Here, a page is an explicit message from a network to a specific node, indicating that the network wants the specified node to establish communication with the network. A first type of access point in a system may provide a backup page for an access terminal that is idling on a second type of access point in the system. Thus, if the access terminal misses a page by the second type of access point, the access point still has an opportunity to receive the backup page.

The disclosure relates in some aspect to providing staggered paging times for a node. For example, an access point of the first type may page the access terminal according to a first paging schedule while an access point of the second type may page the access terminal according to a second paging schedule. In this way, if the access terminal misses a page sent according to one schedule, the access terminal may acquire the page when it is sent according a different schedule.

In some aspects an access point of the first type (e.g., a macro node) provides service over a macro coverage area and an access point of the second type (e.g., a femto node) provides service over a smaller coverage area and/or provides restricted service. Thus, in the event the access terminal misses a page by a femto node, the access terminal may switch over to detect a page by the macro node.

### BRIEF DESCRIPTION OF THE DRAWINGS

These and other sample aspects of the disclosure will be described in the detailed description and the appended claims that follow, and in the accompanying drawings, wherein:

FIG. 1 is a simplified block diagram of several sample aspects of a communication system configured to provide staggered paging;

FIG. 2 is a simplified timing diagram of a sample staggered paging scheme;

FIG. 3 is a flowchart of several sample aspects of operations that may be performed to receive a backup page;

FIG. 4 is a flowchart of several sample aspects of operations that may be performed in a system that utilizes quick pages;

FIG. 5 is a flowchart of several sample aspects of operations that may be performed to provide a backup page;

FIG. 6 is a simplified diagram of a wireless communication system;

FIG. 7 is a simplified diagram of a wireless communication system including femto nodes;

FIG. 8 is a simplified diagram illustrating coverage areas for wireless communication;

FIG. 9 is a simplified block diagram of several sample aspects of communication components; and

FIGS. 10 and 11 are simplified block diagrams of several sample aspects of apparatuses configured to use or provide backup pages as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

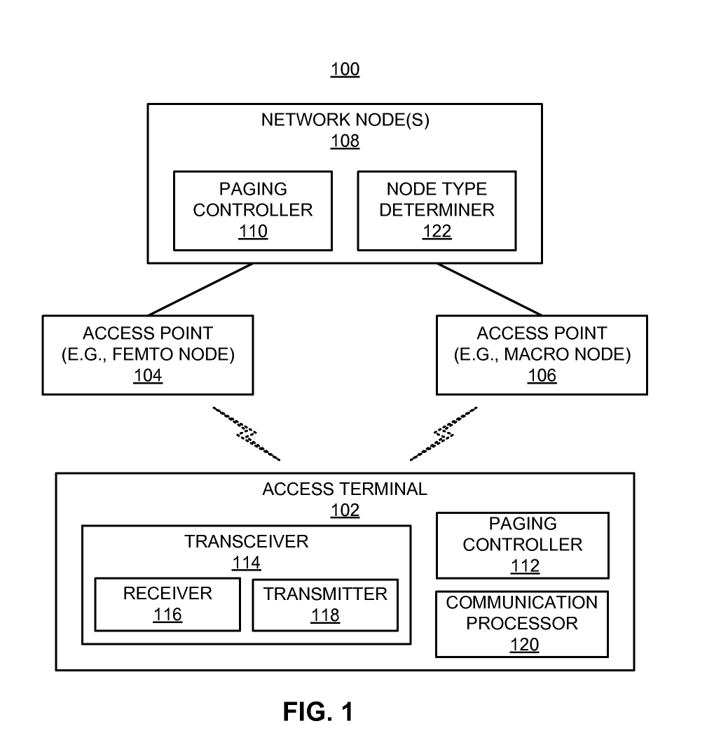

FIG. 1 illustrates several nodes in a sample communication system 100 (e.g., a portion of a communication network). For illustration purposes, various aspects of the disclosure will be described in the context of one or more access terminals, access points, and network nodes that communicate with one another. It should be appreciated, however, that the teachings herein may be applicable to other types of apparatuses or other similar apparatuses that are referenced using other terminology.

Access points 104 and 106 in the system 100 provide one or more services (e.g., network connectivity) for one or more wireless terminals (e.g., access terminal 102) that may reside within or that may roam throughout an associated geographical area. In addition, the access points 104 and 106 may communicate with one or more network nodes (represented, for convenience, by network node 108) to facilitate wide area network connectivity. Such network nodes may take various forms such as, for example, one or more radio and/or core network entities (e.g., a mobility management entity, a session reference network controller, or some other suitable network entity).

FIG. 1 and the discussion that follows describe a paging scheme where different types of access points page the access terminal 102 according to different paging schedules. For example, the access point 104 may comprise a femto node that pages the access terminal 102 according to a first schedule and the access point 106 may comprise a macro node that pages the access terminal 102 according to a second schedule. Through the use of these different paging schedules, the access terminal 102 may receive a page from the access point 106 in the event the access terminal 102 misses a page from the access point 104.

Under certain conditions, a paging channel associated with certain types of nodes (e.g., femto nodes) may be less reliable than a paging channel associated with other types of nodes (e.g., macro nodes). For example, due to reuse, allocated transmit power, or other conditions, the receive interference on a femto paging channel may be higher than on a macro paging channel. To mitigate the effects of such a condition, a backup page may be provided for an access terminal idling on a node of a first type for those time that the access terminal misses a page (e.g., a femto page) provided by that node. Here, the access terminal may switch over to hear a page (e.g., a macro page) provided at a later point in time (e.g., after a defined delay period) by a node of a second type.

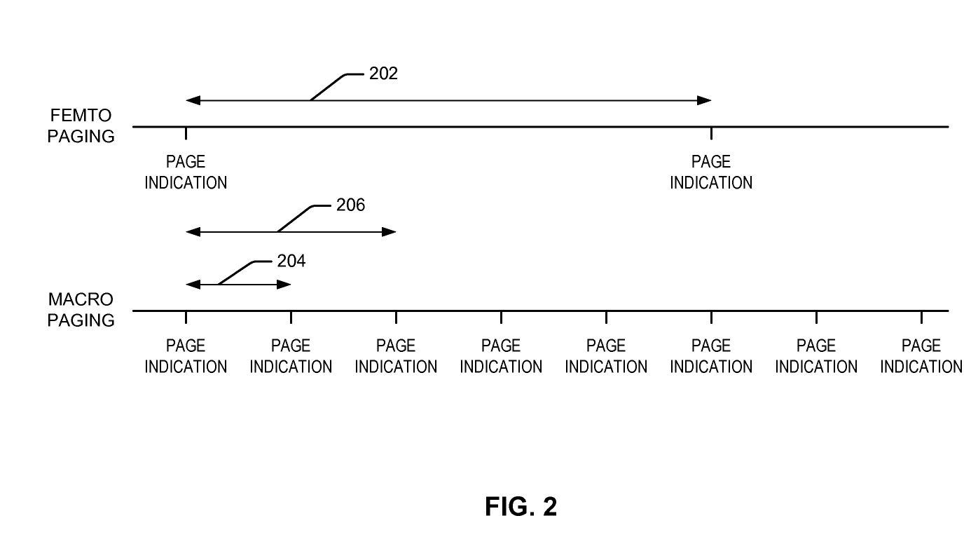

FIG. 2 illustrates an example of how paging for an access terminal may be staggered to provide such a backup page. As will be discussed in more detail below, paging may involve sending a page indication such as, for example, a quick page, a page, a fast page, and a repage. In the example of FIG. 2, femto nodes are configured to send page indications to access terminals according to a defined paging cycle (e.g., every 200 milliseconds as represented by time period 202). In addition, macro nodes are configured to send page indications to access terminals according to a defined paging cycle (e.g., every 50 milliseconds as represented by time period 204).

The specific time at which a page indication is sent to a given access terminal (e.g., during one of the paging opportunities shown in FIG. 2) depends on a timing offset associated with the access terminal. For example, all of the access terminals in a system may wake at five second intervals to monitor for a page, but different access terminals may be assigned different relative time offsets. As a specific example, one access terminal may wake at “absolute” times 1.0, 6.0, 11.0, and so on, while another access terminal may wake at “absolute” times 1.2, 6.2, 11.2, and so on. In some aspects, the timing offset for a given access terminal may be defined as a function (e.g., a hash function) of an identifier associated with that access terminal.

With reference to the example of FIG. 1, the network node 108 (e.g., a paging controller 110) may send a page request to the access points in the system 100 whenever there is a need to communicate with the access terminal 102. Upon receiving the page request, the access point 104 pages the access terminal 102 at the first femto paging opportunity as dictated by a femto paging schedule for the access terminal 102. Similarly, when the access point 106 receives the page request, it may page the access terminal 102 at the first macro paging opportunity as dictated by a macro paging schedule for the access terminal 102. Here, the macro paging opportunity may be defined to be the next macro paging opportunity that occurs after the femto page indication and a suitable delay. For example, the next macro paging opportunity may be defined to occur at least a defined period of time 206 (e.g., greater than 4 super-frames, amounting to 100 milliseconds) after a femto quick page. Here, the macro paging opportunity for a given access terminal may hash to any one out of a given number of macro paging opportunities (e.g., the fourth, fifth, sixth, or seventh macro page indication times shown in FIG. 2). Thus, a given access terminal will be paged at a certain time by femto nodes (e.g., according to a first schedule) and at a defined period of time later by macro nodes (e.g., according to a second schedule).

The access terminal 102 (e.g., a paging controller 112) will cause its transceiver 114 (e.g., including receiver 116 and transmitter 118) to monitor at either the femto paging opportunities or the macro paging opportunities depending on whether the access terminal 102 is idling on the access point 104 or the access point 106, respectively. Moreover, in the event the access terminal 102 is idling on the access point 104 and misses the femto page from the access point 104, the access terminal 102 may be configured to switch over to listen for the macro page from the access point 106.

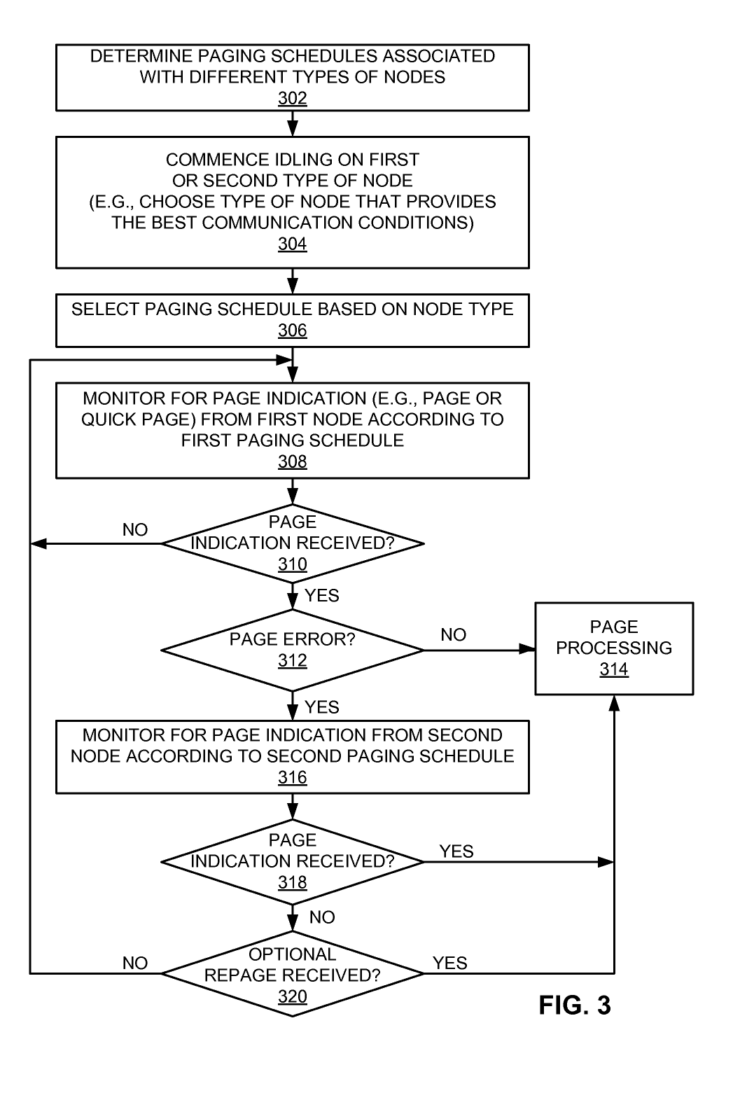

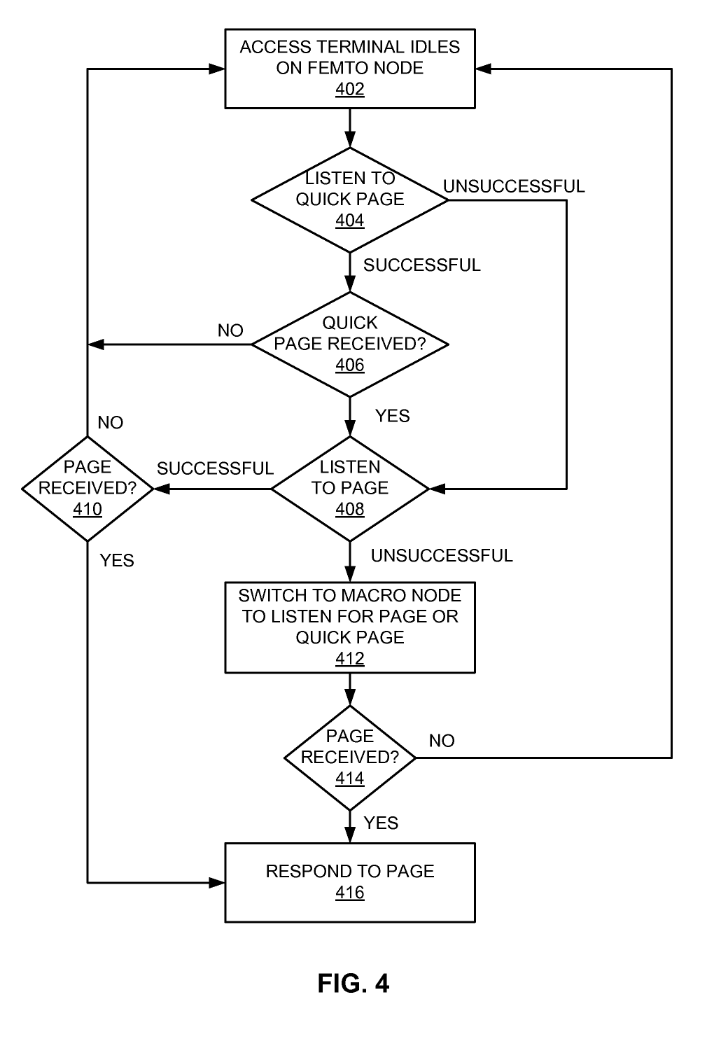

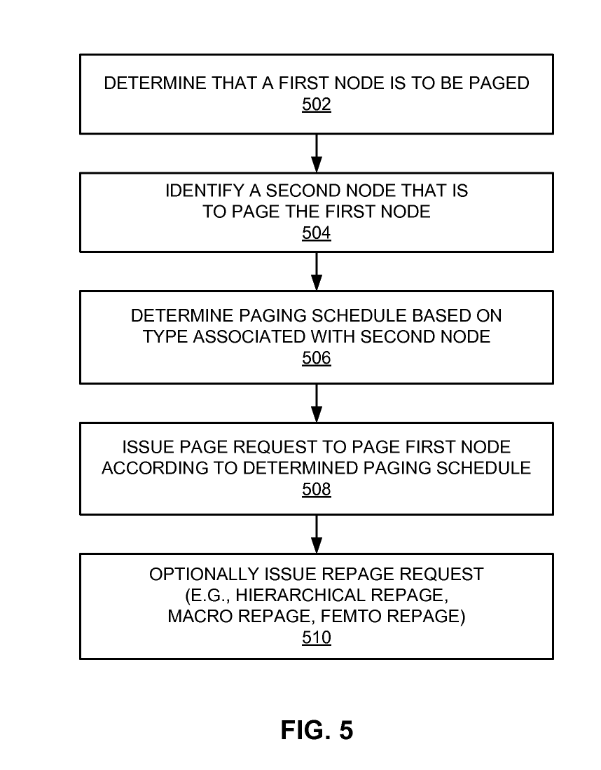

With the above overview in mind, additional details relating to providing backup pages will be described with reference to the flowcharts of FIGS. 3-5. Briefly, FIG. 3 describes sample operations that may be performed by a node such as an access terminal to receive pages. FIG. 4 describes sample operations for a system that utilizes quick pages. FIG. 5 describes sample operations that may be performed by a network node such as a mobility management entity to provide pages.

For convenience, the operations of FIGS. 3-5 (or any other operations discussed or taught herein) may be described as being performed by specific components (e.g., the components of the system 100). It should be appreciated, however, that these operations may be performed by other types of components and may be performed using a different number of components. It also should be appreciated that one or more of the operations described herein may not be employed in a given implementation.

Referring initially to FIG. 3, as represented by block 302, an access terminal determines the different paging schedules that different type of nodes (e.g., access points) will use to page the access terminal. As a simplified example, a first paging schedule may define a timing offset whereby femto nodes page the access terminal at times 1.0, 6.0, 11.0, and so on. In addition, a second paging schedule may define another timing offset whereby macro nodes page the access terminal at times 1.2, 6.2, 11.2, and so on.

As represented by block 304, at some point in time the access terminal will commence idling on a first or second type of node. Here, the access terminal may select the type of node that currently provides the best communication conditions for the access terminal. For example, when the access terminal is at home, the access terminal may idle on a home femto node.

As represented by block 306, the access terminal (e.g., the paging controller 112) may select the paging schedule to use based on the node type of the node that the access terminal is idling on. For example, upon detecting that the access terminal is now idling on a different type of node, the access terminal may switch to a new paging schedule. As mentioned herein, this may involve calculating a timing offset as a function of an identifier of the access terminal.

As represented by block 308, the access terminal (e.g., the receiver 116) is configured (e.g., by the paging controller 112) to monitor for page indications according to the selected paging schedule. Thus, the transceiver 114 may be configured to wake up at the appropriate intervals and timing offsets to scan for pages from one or more femto nodes.

Also, in some cases different types of nodes may communicate on different carrier frequencies. For example, macro nodes may operate on certain designated carriers while femto nodes may operate on different carriers. In such cases, an access terminal may be programmed with an indication of the carriers that may be used by femto nodes.

As represented by block 310, if the access terminal does not hear a page, the access terminal goes back to sleep mode. The access terminal may then wake back up at the next paging opportunity for monitor for the next page (block 308).

As represented by block 312, if the access terminal receives a page during the paging opportunity, the access terminal attempts to decode the page and verify that there are no errors on the page.

As represented by block 314, in the event a page is successfully received, the access terminal may commence page-related processing. For example, in FIG. 1 the access terminal 102 (e.g., a communication processor 120) may cause a page response to be sent to the network node 108.

If the access terminal did not successfully receive the femto page at block 312 (e.g., there is an error on the page or the access terminal is unable to decode the page), the access terminal may then use the paging schedule associated with macro nodes to listen for a page from one or more macro nodes at block 316. As mentioned above, the different paging schedules may be staggered so that the macro page occurs shortly after the femto page.

As mentioned above, in some cases femto nodes and macro nodes may operate on different carriers. Thus, an access terminal may monitor one carrier to receive pages from a femto node and may switch to another carrier to listen for pages from a macro node. Alternatively, in some cases a femto node may be configured to send pages on a carrier used by a macro node (e.g., even if the femto node operates on a different carrier). Here, an access terminal may hear pages from both types of nodes on the same carrier.

As represented by blocks 318 and 314, in the event a page is successfully received, the access terminal may commence page-related processing. Otherwise, the access terminal (e.g., the paging controller 112) may continue to monitor for femto pages according to the first paging schedule (block 308).

As represented by block 320, in some cases the access terminal (e.g., the paging controller 112) may monitor for a repage. As will be discussed in more detail below, a repage may be provided by either type of node (e.g., a femto node or a macro node).

Referring now to FIG. 4, in some cases a system uses a quick page (e.g., a quick paging channel, QPCH) to enable access terminals to more efficiently monitor for pages. A quick page is an efficient method to indicate to an access terminal of a high likelihood that there is a page for it. In such a scheme, only if the access terminal hears a quick page does it try to listen to the entire page (which is a more expensive process for the access terminal, e.g., in terms of consuming battery power). In some aspects a quick page may include an indication that a certain access terminal or certain access terminals may be paged at the next full page interval. However, the indication may not necessarily indicate that a particular access terminal will in fact be paged. For example, the indication may include a portion of an address of each access terminal to be paged. Thus, multiple access terminals may be indicated by the indication even though only a portion (e.g., one) of these access terminals will actually be paged. As a specific example, a quick page may consist of a fixed number of bits (e.g., 40 bits) whereby at least a portion of a node identifier associated with each access terminal that will be paged at the next page interval (e.g., 25 milliseconds after the quick page) is used to define the bits. For example, if one access terminal will be paged, all 40 bits may be derived from an identifier of that access terminal. If two access terminals will be paged, half of the bits may be derived from an identifier of one of the access terminals and the other half of the bits may be derived from an identifier of the other access terminal. Thus, if an access terminal detects a portion of its identifier in a quick page, the access terminal will wake up for the page (which may, in fact, be directed to that access terminal or some other access terminal). Otherwise, the access terminal may elect to not wake up for the page to save battery power. In the example that follows, quick pages may be used in conjunction with femto paging and macro paging (e.g., each page occurs 25 milliseconds after a corresponding quick page).

As represented by block 402 of FIG. 4, at some point in time an access terminal is idling on a femto node. Thus, as represented by block 404, the access terminal will wake up at the times specified by a first paging schedule to monitor for quick pages from a femto node.

As represented by block 406, if a quick page notification was not received, the access terminal continues idling on the femto node and listening for quick pages. That is, if the access terminal successfully read the quick page, but the quick page did not include an indication that the access terminal will be paged at the next page time (e.g., in 25 milliseconds), the access terminal will go back to sleep until the next quick page time.

As represented by block 408, if a quick page notification was received at block 406, the access terminal may wake at the designated time to listen for the femto page. In addition, as represented by the “unsuccessful” branch from block 404, if the access terminal missed the quick page (e.g., the access terminal was not able to successfully decode the quick page due to interference), the access terminal may elect to listen for the full page from the femto node.

As represented by block 410, if the access terminal successfully heard a femto page, the access terminal determines whether the page is directed to that access terminal. If not, the access terminal continues idling on the femto node and listening for quick pages (blocks 402 and 404). If the page is directed to that access terminal, the access terminal responds to the page as represented by block 416.

As represented by block 412, if the access terminal misses the femto page (e.g., the access terminal was not able to successfully decode the full page due to interference), the access terminal listens for the quick page and/or the full page from the macro node(s).

As represented by block 414, if the access terminal successfully heard a macro page, the access terminal responds to the page as represented by block 416. Otherwise, the access terminal may continue idling on the femto node and listening for quick pages (blocks 402 and 404).

It should be appreciated that various modifications may be made to the paging operations taught herein. For example, in some cases, if an access terminal hears a femto quick page but misses the femto page, the access terminal may simply listen for the macro page rather than the macro fast page. In addition, under some conditions a femto quick page may be more reliable than a femto page. Hence, if an access terminal receives a femto quick page, the access terminal may make a direct access (e.g., send a page response), without waiting to hear a femto or macro page. In some cases, an access terminal waits for a femto quick page, a femto page, and a fast repage at the femto before switching to monitor for a page indication from a macro node.

A system may be configured in various ways to use different paging schedules. In a typical case, nodes in the system may be configured (e.g., upon deployment) to support a given paging schedule. For example, femto nodes may be configured to apply one function to an access terminal identifier to come up with the appropriate femto paging schedule for that access terminal, while macro nodes may be configured to apply a different function to an access terminal identifier to come up with the appropriate macro paging schedule for that access terminal. Alternatively, in some cases, the network may schedule page requests for a given access terminal based on the types of nodes that will be paging the access terminal. FIG. 5 illustrates an example where a network node (e.g., a mobility management entity that manages paging for an access terminal) uses different paging schedules to issue page requests.

As represented by block 502 of FIG. 5, at some point in time a network node determines that an access terminal needs to be paged. For example, a call may have been placed to the access terminal or data destined for the access terminal may have been received.

As represented by block 504, the network node (e.g., the paging controller 110 of FIG. 1) identifies one or more nodes (e.g., access points) that are to page the access terminal. In some implementations this may involve paging the access terminal according to the network's standard paging rules (e.g., tracking area-based rules, zone-based rules, distance-based rules). In some implementations a suggested (or supplemental) paging set (“SPS”) may be used instead of or in addition to a standard paging set (e.g., tracking area-based, zone-based, distance-based) that is implemented by the network.

In some aspects, an SPS may take the form of a list that specifies entities that may page the access terminal. In some cases the access terminal may provide this list to an entity that controls paging for the access terminal (e.g., a mobility management entity). For convenience, the following discussion refers to an SPS that includes a list of node identifiers (“IDs”). It should be appreciated, however, that an SPS may include other types of entries (e.g., sector IDs, or cell IDs, subscriber group IDs, etc.). Upon receiving the SPS, the network (e.g., under the control of a mobility manager) may page the access terminal at all nodes specified by the SPS, in addition to the nodes that would page the access terminal according to the network's standard paging rules. Thus, when an access terminal visits a node (e.g., a femto node) that was listed in the latest SPS sent to the network, the access terminal need not register at that node for this visit.

A node (e.g., a given cell or sector) may advertise an indication that indicates that the node may not page an access terminal unless specifically requested to do so (e.g., by registering at the node or including the node in an SPS). A femto node (e.g., a restricted node) is an example of a node that may advertise such an indication. Upon receiving this indication, the access terminal may generate an SPS including the ID of the node and send the SPS to the network (e.g., in a registration message) in the event the access terminal elects to idle at this node. In some implementations, an access terminal may be able to infer the need for an SPS based on one or more of the parameter settings of distance, zone, sector identifier (“SID”), and network identifier (“NID”).

The SPS may be deployed in conjunction with predicting which nodes will be visited by the access terminal in the near future. The use of a forward-looking SPS thus allows the access terminal to reduce its registration load. For example, the access terminal may always add the strongest node (e.g., a sector of the node) it hears to the SPS since there may be a high probability that the access terminal will idle on that node in the near future. For similar reasons, the access terminal may add the neighbors of that access node or any neighbors that the access terminal hears to the SPS. Additionally, if the access terminal can hear its home femto node (e.g., the access terminal is close enough to the home femto node to receive signals from the home femto node), the access terminal may automatically add the home femto node to the SPS since there may be a high probability that the access terminal is going “home.” Similarly, if the access terminal is currently at (e.g., idling on) a home macro cell (e.g., the macro cell which is the strongest neighbor of its home femto node), the access terminal may automatically add the home femto node to its SPS since there may be a high probability that the access terminal is going “home.” The home femto node may be added sooner in this latter case that in the previous case since the access terminal may hear the home macro cell before the access terminal hears the home femto node due to the larger coverage area of the home macro cell. In another case, when an access terminal is idling on a femto node, the access terminal may automatically add a macro neighbor of the femto node to the SPS since the access terminal may likely move out of the coverage of the femto node and into the coverage of the macro.

Referring again to FIG. 5, as represented by block 506, the network node (e.g., a node type determiner 122 in FIG. 1) may determine a paging schedule to use when paging the access terminal based on a node type of each node selected at block 504. For example, as discussed herein, a first paging schedule may be selected for femto nodes and a second paging schedule selected for macro nodes.

As represented by block 508, the network node (e.g., the paging controller 110) issues a page request to each selected node. Here, a given page request may request the node (e.g., access point) to page the access terminal according to the appropriate paging schedule as determined at block 506.

As represented by block 510, in some implementations, if the network does not receive a response to a page, the network (e.g., the paging controller 110) may initiate a repage operation. For example, a network node may resend the page the next time the access terminal is scheduled to wake for a page or at some earlier defined time (e.g., a fast repage).

A repage operation in this case or any other case may be implemented in various ways. For example, in some cases hierarchical repaging may be employed. In some cases, a femto node may be configured to repage. In some cases, a macro node may be configured to repage. Sample operations for each of these cases will be described in turn.

In hierarchical repaging, a network node initially causes the access terminal to be paged within an area that the access terminal was last known to be in. If there is no response, the network node causes the access terminal to be paged over a larger area (e.g., over a larger distance, a larger zone, or additional zones) after a defined repage interval. The access terminal, in turn, is configured to wake up for the first page attempt if it is within the smaller area. Otherwise, the access terminal wakes up for the second page attempt. Here, any node (e.g., sector, cell, etc.) listed in an SPS is paged in the first paging attempt. Thus, an access terminal idling on a node specified in the SPS of the access terminal will be configured to wake up for the first paging attempt.

In some aspects, femto repaging may be employed to prevent an access terminal from missing a page when the access terminal is moving from a macro node to a femto node. For example, an access terminal may switch from idling on a macro node to idling on a femto node during the period of time that follows a femto page but precedes the corresponding backup macro page. In this case, the access terminal may miss the femto quick page and page. To overcome this problem, the femto node may automatically repage the access terminal after a defined automatic repage interval (e.g., that is greater than the switching time period 206 of FIG. 2).

In some aspects, macro repaging may be employed to prevent an access terminal from missing a page when the access terminal is moving from a macro node to a femto node. For example, an access terminal may switch from idling on a macro node to idling on a femto node during the period of time between a femto page opportunity and a macro page, in a circumstance where the network issues a page request during this period of time. In this case, the macro page will occur before the femto page, whereby the macro page may by ignored by the access terminal since the access terminal is now idling on the femto node. Here, the access terminal may not even listen for a fast repage (if supported) since the access terminal may hear the next macro fast page and determined that there is no page for the access terminal.

To address this problem, the network node may either automatically send two pages or send one page that includes an automatic repage request (e.g., flag). In the former case, the pages may be sent a sufficient period of time apart (e.g., 100 milliseconds). Here, if the macro node receives both pages within the same paging interval, the macro node may merge them into a single page. Alternatively, the macro node may send 2 consecutive pages on the macro paging channel. If the page includes an automatic repage request, the macro node may send 2 consecutive pages on the macro paging channel if it determines that that femto paging opportunity has passed.

In some aspects, the network may perform repaging based on information relating to the current node that the access terminal is idling on. For example, a network node may perform a repage if the SPS for an access terminal includes a femto node. In addition, a macro node may repage based on information it acquired regarding the paging opportunities of the femto node.

In view of the above, it should be appreciated that an access terminal may adjust its wakeup timing based on which type of node the access terminal is idling on and based on any repaging that may be employed in the system. For example, when an access terminal is transitioning from idling on a macro node to idling on a femto node, or vice versa, the access terminal may change its wakeup timing to account for different paging schedules.

As mentioned above, in some aspects the teachings herein may be employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal (“AT”) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience). As discussed above, a node that provides coverage over a relatively large area may be referred to as a macro node while a node that provides coverage over a relatively small area (e.g., a residence) may be referred to as a femto node. A node that provides coverage over an area that is smaller than a macro area and larger than a femto area may be referred to as a pico node (e.g., providing coverage within a commercial building).

In some implementations, a node may be associated with (e.g., divided into) one or more cells or sectors. A cell or sector associated with a macro node, a femto node, or a pico node may be referred to as a macro cell, a femto cell, or a pico cell, respectively.

In various applications, other terminology may be used to reference a macro node, a femto node, or a pico node. For example, a macro node may be configured or referred to as an access node, base station, access point, eNodeB, macro cell, and so on. Also, a femto node may be configured or referred to as a Home NodeB, Home eNodeB, access point base station, femto cell, and so on.

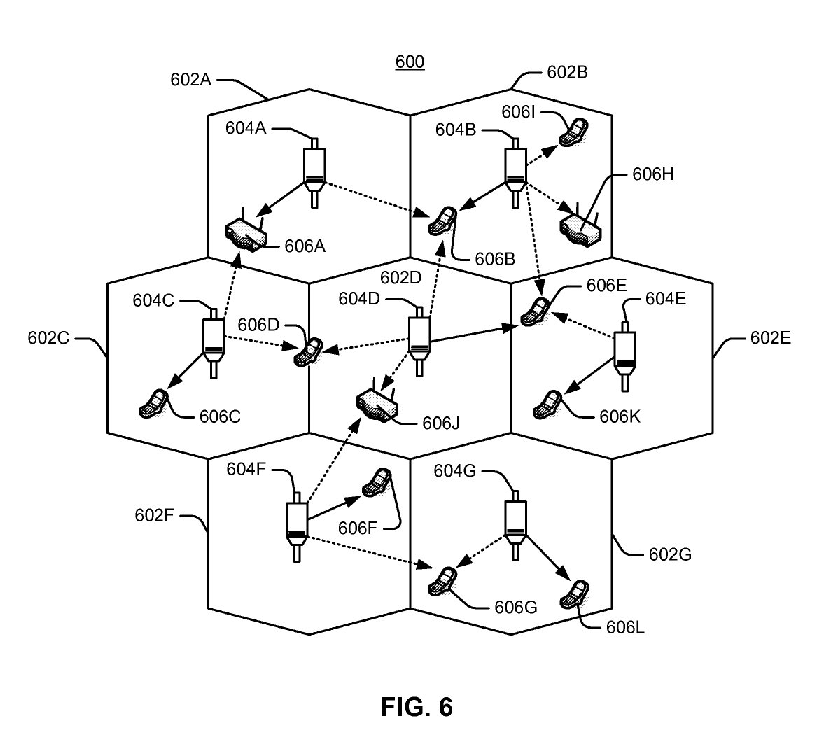

FIG. 6 illustrates an example of a wireless communication system 600, configured to support a number of users, in which the teachings herein may be implemented. The system 600 provides communication for multiple cells 602, such as, for example, macro cells 602A-602G, with each cell being serviced by a corresponding access point 604 (e.g., access points 604A-604G). As shown in FIG. 6, access terminals 606 (e.g., access terminals 606A-606L) may be dispersed at various locations throughout the system over time. Each access terminal 606 may communicate with one or more access points 604 on a forward link (“FL”) and/or a reverse link (“RL) at a given moment, depending upon whether the access terminal 606 is active and whether it is in soft handoff, for example. The wireless communication system 600 may provide service over a large geographic region. For example, macro cells 602A-602G may cover a few blocks in a neighborhood or several miles in rural environment.

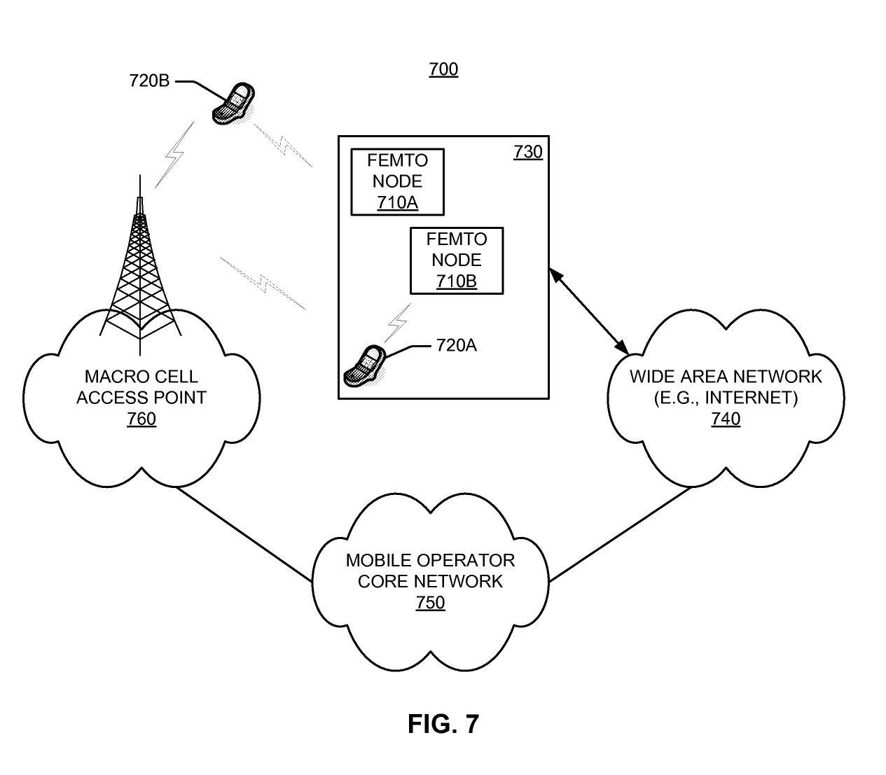

FIG. 7 illustrates an example of a communication system 700 where one or more femto nodes are deployed within a network environment. Specifically, the system 700 includes multiple femto nodes 710 (e.g., femto nodes 710A and 710B) installed in a relatively small scale network environment (e.g., in one or more user residences 730). Each femto node 710 may be coupled to a wide area network 740 (e.g., the Internet) and a mobile operator core network 750 via a DSL router, a cable modem, a wireless link, or other connectivity means (not shown). As will be discussed below, each femto node 710 may be configured to serve associated access terminals 720 (e.g., access terminal 720A) and, optionally, alien access terminals 720 (e.g., access terminal 720B). In other words, access to femto nodes 710 may be restricted whereby a given access terminal 720 may be served by a set of designated (e.g., home) femto node(s) 710 but may not be served by any non-designated femto nodes 710 (e.g., a neighbor's femto node 710).

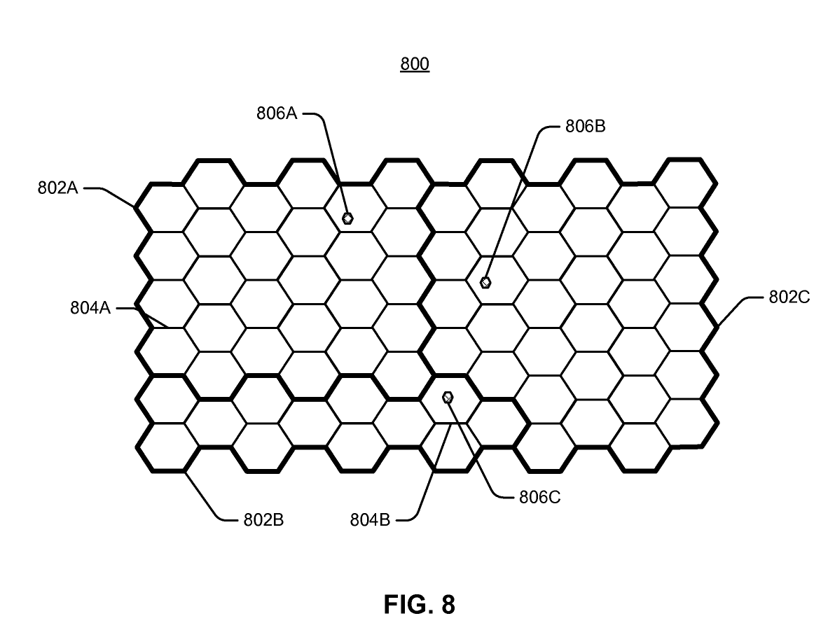

FIG. 8 illustrates an example of a coverage map 800 where several tracking areas 802 (or routing areas or location areas) are defined, each of which includes several macro coverage areas 804. Here, areas of coverage associated with tracking areas 802A, 802B, and 802C are delineated by the wide lines and the macro coverage areas 804 are represented by the hexagons. The tracking areas 802 also include femto coverage areas 806. In this example, each of the femto coverage areas 806 (e.g., femto coverage area 806C) is depicted within a macro coverage area 804 (e.g., macro coverage area 804B). It should be appreciated, however, that a femto coverage area 806 may not lie entirely within a macro coverage area 804. In practice, a large number of femto coverage areas 806 may be defined with a given tracking area 802 or macro coverage area 804. Also, one or more pico coverage areas (not shown) may be defined within a given tracking area 802 or macro coverage area 804.

Referring again to FIG. 7, the owner of a femto node 710 may subscribe to mobile service, such as, for example, 3G mobile service, offered through the mobile operator core network 750. In addition, an access terminal 720 may be capable of operating both in macro environments and in smaller scale (e.g., residential) network environments. In other words, depending on the current location of the access terminal 720, the access terminal 720 may be served by a macro cell access point 760 associated with the mobile operator core network 750 or by any one of a set of femto nodes 710 (e.g., the femto nodes 710A and 710B that reside within a corresponding user residence 730). For example, when a subscriber is outside his home, he is served by a standard macro access point (e.g., access point 760) and when the subscriber is at home, he is served by a femto node (e.g., node 710A). Here, a femto node 710 may be backward compatible with legacy access terminals 720.

A femto node 710 may be deployed on a single frequency or, in the alternative, on multiple frequencies. Depending on the particular configuration, the single frequency or one or more of the multiple frequencies may overlap with one or more frequencies used by a macro access point (e.g., access point 760).

In some aspects, an access terminal 720 may be configured to connect to a preferred femto node (e.g., the home femto node of the access terminal 720) whenever such connectivity is possible. For example, whenever the access terminal 720A is within the user's residence 730, it may be desired that the access terminal 720A communicate only with the home femto node 710A or 710B.

In some aspects, if the access terminal 720 operates within the macro cellular network 750 but is not residing on its most preferred network (e.g., as defined in a preferred roaming list), the access terminal 720 may continue to search for the most preferred network (e.g., the preferred femto node 710) using a Better System Reselection (“BSR”), which may involve a periodic scanning of available systems to determine whether better systems are currently available, and subsequent efforts to associate with such preferred systems. In some cases the access terminal 720 may limit the search for a specific band and channel. In some cases the search for the most preferred system may be repeated periodically. Upon discovery of a preferred femto node 710, the access terminal 720 selects the femto node 710 for camping within its coverage area.

A femto node may be restricted in some aspects. For example, a given femto node may only provide certain services to certain access terminals. In deployments with so-called restricted (or closed) association, a given access terminal may only be served by the macro cell mobile network and a defined set of femto nodes (e.g., the femto nodes 710 that reside within the corresponding user residence 730). In some implementations, a node (e.g., an access point) may be restricted to not provide, for at least one node, at least one of: signaling, data access, registration, paging, or service.

In some aspects, a restricted femto node (which may also be referred to as a Closed Subscriber Group Home NodeB) is one that provides service to a restricted provisioned set of access terminals. This set may be temporarily or permanently extended as necessary. In some aspects, a Closed Subscriber Group (“CSG”) may be defined as the set of access points (e.g., femto nodes) that share a common access control list of access terminals. A channel on which all femto nodes (or all restricted femto nodes) in a region operate may be referred to as a femto channel.

Various relationships may thus exist between a given femto node and a given access terminal. For example, from the perspective of an access terminal, an open femto node may refer to a femto node with no restricted association (e.g., the femto node allows access to any access terminal). A restricted femto node may refer to a femto node that is restricted in some manner (e.g., restricted for association and/or registration). A home femto node may refer to a femto node on which the access terminal is authorized to access and operate on (e.g., permanent access is provided for a defined set of one or more access terminals). A guest femto node may refer to a femto node on which an access terminal is temporarily authorized to access or operate on. An alien femto node may refer to a femto node on which the access terminal is not authorized to access or operate on, except for perhaps emergency situations (e.g., 911 calls).

From a restricted femto node perspective, a home access terminal may refer to an access terminal that is authorized to access the restricted femto node (e.g., the access terminal has permanent access to the femto node). A guest access terminal may refer to an access terminal with temporary access to the restricted femto node (e.g., limited based on deadline, time of use, bytes, connection count, or some other criterion or criteria). An alien access terminal may refer to an access terminal that does not have permission to access the restricted femto node, except for perhaps emergency situations, for example, such as 911 calls (e.g., an access terminal that does not have the credentials or permission to register with the restricted femto node).

For convenience, the disclosure herein describes various functionality in the context of a femto node. It should be appreciated, however, that a pico node may provide the same or similar functionality for a larger coverage area. For example, a different paging schedule may be assigned to pico nodes, a pico node may be restricted, a home pico node may be defined for a given access terminal, and so on.

A wireless multiple-access communication system may simultaneously support communication for multiple wireless access terminals. Each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (“MIMO”) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min {N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

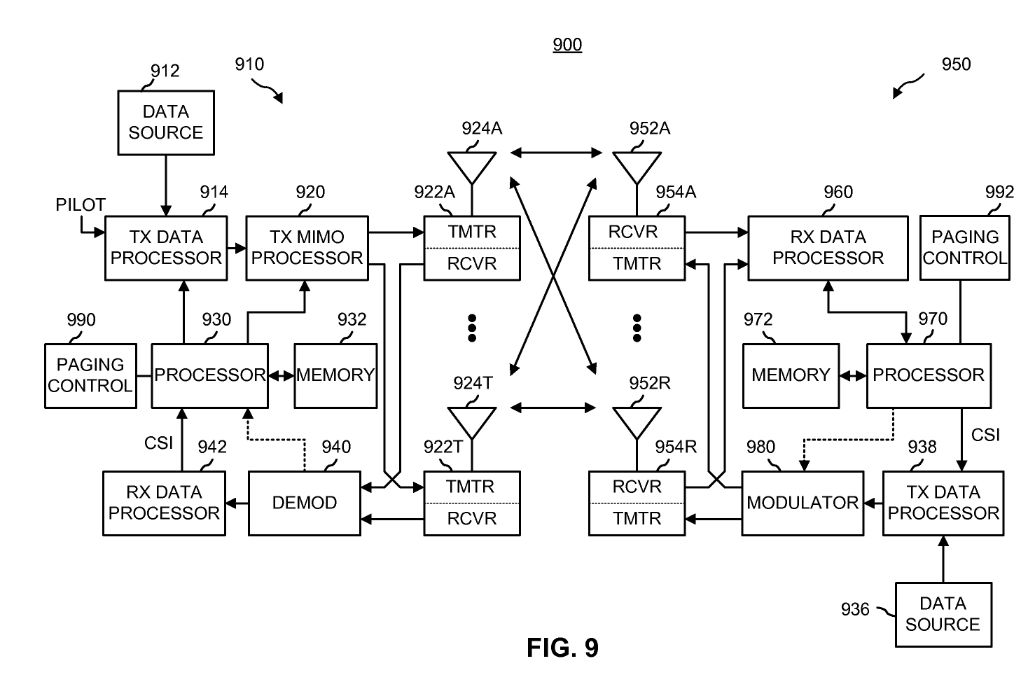

The teachings herein may be incorporated into a node (e.g., a device) employing various components for communicating with at least one other node. FIG. 9 depicts several sample components that may be employed to facilitate communication between nodes. Specifically, FIG. 9 illustrates a wireless device 910 (e.g., an access point) and a wireless device 950 (e.g., an access terminal) of a MIMO system 900. At the device 910, traffic data for a number of data streams is provided from a data source 912 to a transmit (“TX”) data processor 914.

In some aspects, each data stream is transmitted over a respective transmit antenna. The TX data processor 914 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 930. A data memory 932 may store program code, data, and other information used by the processor 930 or other components of the device 910.

The modulation symbols for all data streams are then provided to a TX MIMO processor 920, which may further process the modulation symbols (e.g., for OFDM). The TX MIMO processor 920 then provides N_{T} modulation symbol streams to N_{T} transceivers (“XCVR”) 922A through 922T. In some aspects, the TX MIMO processor 920 applies beam-forming weights to the symbols of the data streams and to the antenna from which the symbol is being transmitted.

Each transceiver 922 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 922A through 922T are then transmitted from N_{T} antennas 924A through 924T, respectively.

At the device 950, the transmitted modulated signals are received by N_{R} antennas 952A through 952R and the received signal from each antenna 952 is provided to a respective transceiver (“XCVR”) 954A through 954R. Each transceiver 954 conditions (e.g., filters, amplifies, and downconverts) a respective received signal, digitizes the conditioned signal to provide samples, and further processes the samples to provide a corresponding “received” symbol stream.

A receive (“RX”) data processor 960 then receives and processes the N_{R} received symbol streams from N_{R} transceivers 954 based on a particular receiver processing technique to provide N_{T} “detected” symbol streams. The RX data processor 960 then demodulates, deinterleaves, and decodes each detected symbol stream to recover the traffic data for the data stream. The processing by the RX data processor 960 is complementary to that performed by the TX MIMO processor 920 and the TX data processor 914 at the device 910.

A processor 970 periodically determines which pre-coding matrix to use (discussed below). The processor 970 formulates a reverse link message comprising a matrix index portion and a rank value portion. A data memory 972 may store program code, data, and other information used by the processor 970 or other components of the device 950.

The reverse link message may comprise various types of information regarding the communication link and/or the received data stream. The reverse link message is then processed by a TX data processor 938, which also receives traffic data for a number of data streams from a data source 936, modulated by a modulator 980, conditioned by the transceivers 954A through 954R, and transmitted back to the device 910.

At the device 910, the modulated signals from the device 950 are received by the antennas 924, conditioned by the transceivers 922, demodulated by a demodulator (“DEMOD”) 940, and processed by a RX data processor 942 to extract the reverse link message transmitted by the device 950. The processor 930 then determines which pre-coding matrix to use for determining the beam-forming weights then processes the extracted message.

FIG. 9 also illustrates that the communication components may include one or more components that perform paging control operations as taught herein. For example, a paging control component 990 may cooperate with the processor 930 and/or other components of the device 910 to send/receive signals to/from another device (e.g., device 950) as taught herein. Similarly, a paging control component 992 may cooperate with the processor 970 and/or other components of the device 950 to send/receive signals to/from another device (e.g., device 910). It should be appreciated that for each device 910 and 950 the functionality of two or more of the described components may be provided by a single component. For example, a single processing component may provide the functionality of the paging control component 990 and the processor 930 and a single processing component may provide the functionality of the paging control component 992 and the processor 970.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (“CDMA”) systems, Multiple-Carrier CDMA (“MCCDMA”), Wideband CDMA (“W-CDMA”), High-Speed Packet Access (“HSPA,” “HSPA+”) systems, Time Division Multiple Access (“TDMA”) systems, Frequency Division Multiple Access (“FDMA”) systems, Single-Carrier FDMA (“SC-FDMA”) systems, Orthogonal Frequency Division Multiple Access (“OFDMA”) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (“UTRA)”, cdma2000, or some other technology. UTRA includes W-CDMA and Low Chip Rate (“LCR”). The cdma2000 technology covers IS-2000, IS-95 and IS-856 standards. A TDMA network may implement a radio technology such as Global System for Mobile Communications (“GSM”). An OFDMA network may implement a radio technology such as Evolved UTRA (“E-UTRA”), IEEE 802.11, IEEE 802.16, IEEE 802.20, Flash-OFDM®, etc. UTRA, E-UTRA, and GSM are part of Universal Mobile Telecommunication System (“UMTS”). The teachings herein may be implemented in a 3GPP Long Term Evolution (“LTE”) system, an Ultra-Mobile Broadband (“UMB”) system, and other types of systems. LTE is a release of UMTS that uses E-UTRA. Although certain aspects of the disclosure may be described using 3GPP terminology, it is to be understood that the teachings herein may be applied to 3GPP (Re199, Re15, Re16, Re17) technology, as well as 3GPP2 (IxRTT, 1xEV-DO RelO, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a Home eNodeB, a radio network controller (“RNC”), a base station (“BS”), a radio base station (“RBS”), a base station controller (“BSC”), a base transceiver station (“BTS”), a transceiver function (“TF”), a radio transceiver, a radio router, a basic service set (“BSS”), an extended service set (“ESS”), or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

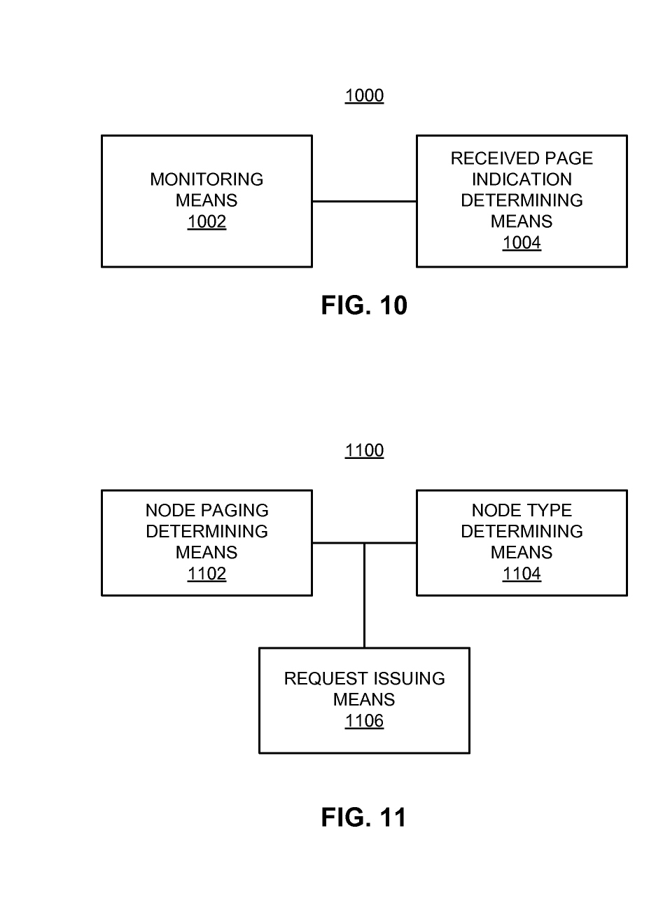

The components described herein may be implemented in a variety of ways. Referring to FIGS. 10 and 11, apparatuses 1000 and 1100 are represented as a series of interrelated functional blocks. In some aspects the functionality of these blocks may be implemented as a processing system including one or more processor components. In some aspects the functionality of these blocks may be implemented using, for example, at least a portion of one or more integrated circuits (e.g., an ASIC). As discussed herein, an integrated circuit may include a processor, software, other related components, or some combination thereof The functionality of these blocks also may be implemented in some other manner as taught herein.

The apparatuses 1000 and 1100 may include one or more modules that may perform one or more of the functions described above with regard to various figures. For example, a monitoring means 1002 may correspond to, for example, a receiver as discussed herein. A received page indication determining means 1004 may correspond to, for example, a paging controller as discussed herein. A node paging determining means 1102 may correspond to, for example, a paging controller as discussed herein. A node type determining means 1104 may correspond to, for example, a node type determiner as discussed herein. A request issuing means 1106 may correspond to, for example, a paging controller as discussed herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. In summary, it should be appreciated that a computer-readable medium may be implemented in any suitable computer-program product.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method of wireless communication, comprising:
monitoring for a first page indication from a first node according to a first paging schedule; and
monitoring for a second page indication from a second node according to a second paging schedule if the first page indication was not received from the first node.

2. The method of claim 1, wherein:
the first paging schedule is associated with a first type of node; and
the second paging schedule is associated with a second type of node.

3. The method of claim 2, wherein:
the first type of node comprises a femto node or a pico node; and
the second type of node comprises a macro mode.

4. The method of claim 1, wherein the first type of node is restricted to not provide, for at least one node, at least one of the group consisting of: signaling, data access, registration, and paging.

5. The method of claim 1, wherein:
the first paging schedule defines a first paging time;
the second paging schedule defines a second paging time; and
the second paging time follows the first paging time by a defined period of time.

6. The method of claim 1, further comprising monitoring for a repage from the first node in conjunction with a switch from idling on the second node to idling on the first node.

7. The method of claim 1, wherein:
the monitoring for the first page indication from the first node is enabled based on a determination that a node that performs the monitoring is now idling on the first node; and
the first node comprises a femto node or a pico node.

8. The method of claim 1, wherein the monitoring for the first and second page indications is performed at an access terminal.

9. The method of claim 1, wherein the first page indication is a quick page, a page, or a repage.

10. The method of claim 1, wherein the second page indication is a quick page, a page, or a repage.

11. An apparatus for wireless communication, comprising:
a receiver configured to monitor for a first page indication from a first node according to a first paging schedule; and
a paging controller configured to determine whether the first page indication was received from the first node,
wherein the receiver is further configured to monitor for a second page indication from a second node according to a second paging schedule if the first page indication was not received from the first node.

12. The apparatus of claim 11, wherein:
the first paging schedule is associated with a first type of node; and
the second paging schedule is associated with a second type of node.

13. The apparatus of claim 12, wherein:
the first type of node comprises a femto node or a pico node; and
the second type of node comprises a macro mode.

14. The apparatus of claim 11, wherein the first type of node is restricted to not provide, for at least one node, at least one of the group consisting of: signaling, data access, registration, and paging.

15. The apparatus of claim 11, wherein:
the first paging schedule defines a first paging time;
the second paging schedule defines a second paging time; and
the second paging time follows the first paging time by a defined period of time.

16. The apparatus of claim 11, the receiver is further configured to monitor for a repage from the first node in conjunction with a switch from idling on the second node to idling on the first node.

17. The apparatus of claim 11, wherein:
the monitoring for the first page indication from the first node is enabled based on a determination that a node that performs the monitoring is now idling on the first node; and
the first node comprises a femto node or a pico node.

18. The apparatus of claim 11, wherein the apparatus comprises an access terminal.

19. The apparatus of claim 11, wherein the first page indication is a quick page, a page, or a repage.

20. The apparatus of claim 11, wherein the second page indication is a quick page, a page, or a repage.

21. An apparatus for wireless communication, comprising:
means for monitoring for a first page indication from a first node according to a first paging schedule; and
means for determining whether the first page indication was received from the first node,
wherein the means for monitoring is configured to monitor for a second page indication from a second node according to a second paging schedule if the first page indication was not received from the first node.

22. The apparatus of claim 21, wherein:
the first paging schedule is associated with a first type of node; and
the second paging schedule is associated with a second type of node.

23. The apparatus of claim 22, wherein:
the first type of node comprises a femto node or a pico node; and
the second type of node comprises a macro mode.

24. The apparatus of claim 21, wherein the first type of node is restricted to not provide, for at least one node, at least one of the group consisting of: signaling, data access, registration, and paging.

25. The apparatus of claim 21, wherein:
the first paging schedule defines a first paging time;
the second paging schedule defines a second paging time; and
the second paging time follows the first paging time by a defined period of time.

26. The apparatus of claim 21, the means for monitoring is configured to monitor for a repage from the first node in conjunction with a switch from idling on the second node to idling on the first node.

27. The apparatus of claim 21, wherein:
the monitoring for the first page indication from the first node is enabled based on a determination that a node that performs the monitoring is now idling on the first node; and
the first node comprises a femto node or a pico node.

28. The apparatus of claim 21, wherein the apparatus comprises an access terminal.

29. The apparatus of claim 21, wherein the first page indication is a quick page, a page, or a repage.

30. The apparatus of claim 21, wherein the second page indication is a quick page, a page, or a repage.

31. A computer-program product, comprising:
computer-readable medium comprising code for causing a computer to:
monitor for a first page indication from a first node according to a first paging schedule; and
monitor for a second page indication from a second node according to a second paging schedule if the first page indication was not received from the first node.

32. The computer-program product of claim 31, wherein:
the first paging schedule is associated with a first type of node; and
the second paging schedule is associated with a second type of node.

33. The computer-program product of claim 32, wherein:
the first type of node comprises a femto node or a pico node; and
the second type of node comprises a macro mode.

34. The computer-program product of claim 31, wherein the first type of node is restricted to not provide, for at least one node, at least one of the group consisting of: signaling, data access, registration, and paging.

35. The computer-program product of claim 31, wherein:
the first paging schedule defines a first paging time;
the second paging schedule defines a second paging time; and
the second paging time follows the first paging time by a defined period of time.

36. The computer-program product of claim 31, wherein the computer-readable medium further comprises code for causing the computer to monitor for a repage from the first node in conjunction with a switch from idling on the second node to idling on the first node.

37. The computer-program product of claim 31, wherein:
the monitoring for the first page indication from the first node is enabled based on a determination that a node that performs the monitoring is now idling on the first node; and
the first node comprises a femto node or a pico node.

38. The computer-program product of claim 31, wherein the apparatus comprises an access terminal.

39. The computer-program product of claim 31, wherein the first page indication is a quick page, a page, or a repage.

40. The computer-program product of claim 31, wherein the second page indication is a quick page, a page, or a repage.

41. A method of wireless communication, comprising:
determining that a first node is to be paged by a second node;
determining a node type of the second node; and
issuing a request to page the first node according to a paging schedule that is based on the determined node type.

42. The method of claim 41, wherein the determined node type comprises a femto type, a pico type or a macro type.

43. The method of claim 41, wherein the second node is restricted to not provide, for at least one node, at least one of the group consisting of: signaling, data access, registration, and paging.

44. The method of claim 41, further comprising issuing a repage request if a response to paging of the first node was not received, wherein the paging of the first node is associated with a first paging area that is smaller than a second paging area that is associated with the repage request.

45. The method of claim 41, further comprising issuing a repage request if a response to paging of the first node was not received, wherein the request to page is sent to a first quantity of nodes that is smaller than a second quantity of nodes to which the repage request is sent.

46. An apparatus for wireless communication, comprising:
a paging controller configured to determine that a first node is to be paged by a second node; and
a node type determiner configured to determine a node type of the second node,
wherein the paging controller is further configured to issue a request to page the first node according to a paging schedule that is based on the determined node type.

47. The apparatus of claim 46, wherein the determined node type comprises a femto type, a pico type or a macro type.

48. The apparatus of claim 46, wherein the second node is restricted to not provide, for at least one node, at least one of the group consisting of: signaling, data access, registration, and paging.

49. The apparatus of claim 46, wherein the paging controller is further configured to issue a repage request if a response to paging of the first node was not received, wherein the paging of the first node is associated with a first paging area that is smaller than a second paging area that is associated with the repage request.

50. The apparatus of claim 46, wherein the paging controller is further configured to issue a repage request if a response to paging of the first node was not received, wherein the request to page is sent to a first quantity of nodes that is smaller than a second quantity of nodes to which the repage request is sent.

51. An apparatus for wireless communication, comprising:
means for determining that a first node is to be paged by a second node;
means for determining a node type of the second node; and
means for issuing a request to page the first node according to a paging schedule that is based on the determined node type.

52. The apparatus of claim 51, wherein the determined node type comprises a femto type, a pico type or a macro type.

53. The apparatus of claim 51, wherein the second node is restricted to not provide, for at least one node, at least one of the group consisting of: signaling, data access, registration, and paging.

54. The apparatus of claim 51, wherein the means for issuing is configured to issue a repage request if a response to paging of the first node was not received, wherein the paging of the first node is associated with a first paging area that is smaller than a second paging area that is associated with the repage request.

55. The apparatus of claim 51, wherein the means for issuing is configured to issue a repage request if a response to paging of the first node was not received, wherein the request to page is sent to a first quantity of nodes that is smaller than a second quantity of nodes to which the repage request is sent.

56. A computer-program product, comprising:
computer-readable medium comprising code for causing a computer to:
determine that a first node is to be paged by a second node;
determine a node type of the second node; and
issue a request to page the first node according to a paging schedule that is based on the determined node type.

57. The computer-program product of claim 56, wherein the determined node type comprises a femto type, a pico type or a macro type.

58. The computer-program product of claim 56, wherein the second node is restricted to not provide, for at least one node, at least one of the group consisting of: signaling, data access, registration, and paging.

59. The computer-program product of claim 56, wherein the computer-readable medium further comprises code for causing the computer to issue a repage request if a response to paging of the first node was not received, wherein the paging of the first node is associated with a first paging area that is smaller than a second paging area that is associated with the repage request.

60. The computer-program product of claim 56, wherein the computer-readable medium further comprises code for causing the computer to issue a repage request if a response to paging of the first node was not received, wherein the request to page is sent to a first quantity of nodes that is smaller than a second quantity of nodes to which the repage request is sent.
